(19) United States
(12) Patent Application Publication
(10) Pub. No.: US 2008/0264769 A1
(43) Pub. Date: Oct. 30, 2008

(54) ELECTRICAL SWITCH

(75) Inventor: Kin Yu Wong, Hong Kong SAR (CN)

Correspondence Address: LEYDIG VOIT & MAYER, LTD, 700 THIRTEENTH ST. NW, SUITE 300, WASHINGTON, DC, 20005-3960, US

(73) Assignee: DEFOND COMPONENTS LIMITED, Chaiwan (CN)

(21) Appl. No.: 11/741,825

(22) Filed: Apr. 30, 2007

(51) Int. Cl. H01H 5/00

(52) U.S. Cl. 200/400

(57) ABSTRACT

An electrical switch has two fixed contacts and a moving contact, a spring urging the moving contact towards contacting the fixed contacts, and an actuating mechanism for moving the moving contact away from the fixed contacts against urging by the spring and, alternatively, allowing the moving contact to contact the fixed contacts under the action of the spring. The actuating mechanism has an engaging member for engaging and retaining the moving contact and includes a spring acting on the engaging member for separating the moving contact from the fixed contacts through an instant spring-release action. One of the engaging member and the contacts is configured such that the moving contact will be engaged and moved by the engaging member out of contact with one of the fixed contacts earlier than with the other fixed contact.

The present invention relates to an electrical switch.

### BACKGROUND OF THE INVENTION

An electrical switch of the kind concerned typically has a casing, two fixed contacts, and a moving contact which is resiliently biased towards contacting the fixed contacts, whereby the switch is closed. A spring-loaded actuator is used to bring about movement of the moving contact relative to the fixed contacts, and in particular to move the moving contact out of contact from the fixed contacts for opening the switch.

During opening of the switch, it is unpredictable as to which one of the fixed contacts the moving contact is to leave last. This is a concern in the design of heavy-current switches as arcing and/or flashover often occur at where the circuit is opened i.e. across the moving contact and the fixed contact it departs last. Of course, both fixed contacts together with the moving contact can be enhanced for better performance, for example made larger and/or coated with platinum, but production cost will escalate. Another consideration is the speed at which the moving contact is separated from the fixed contacts.

The invention seeks to provide an improved electrical switch of this type in general.

### SUMMARY OF THE INVENTION

According to the invention, there is provided an electrical switch comprising a casing, two fixed contacts and a moving contact in the casing, a first spring resiliently biasing the moving contact towards contacting the fixed contacts to thereby close the switch, and an actuating mechanism for causing movement of the moving contact relative to the fixed contacts. The actuating mechanism is operable between a first operating condition in which the moving contact is moved out of contact from the fixed contacts against the action of the first spring and a second operating condition in which the moving contact is allowed to come into contact with the fixed contacts under the action of the first spring. The actuating mechanism has an engaging member for engaging and retaining the moving contact from contacting the fixed contacts in the first operating condition and includes a second spring acting on the engaging member for moving the moving contact out of contact from the fixed contacts through an instant spring-release action. At least one of the engaging member and the contacts is configured such that the moving contact will be engaged and moved by the engaging member out of contact from a predetermined first of the fixed contacts earlier than the second fixed contact.

Preferably, the engaging member is arranged to engage the moving contact at a position on one side of the moving contact about the first spring relatively closer to the first fixed contact than the second fixed contact.

More preferably, the engaging member has a first region arranged to initially engage the moving contact at said position on one side of the moving contact about the first spring relatively closer to the first fixed contact than the second fixed contact, and includes a second region arranged to subsequently engage the moving contact at another position on the opposite side of the moving contact about the first spring.

Further more preferably, the first and second regions lie on a plane which is inclined at a small angle relative to the two fixed contacts.

Yet further more preferably, the first and second regions are provided by a flat surface of the engaging member on said plane.

It is preferred that the moving contact has a straight body.

In a preferred embodiment, the actuating mechanism includes a first actuating member for manual movement and a second actuating member comprising the engaging member and movable by the first actuating member via the second spring past a maximum strain condition thereof to perform said instant spring-release action.

More preferably, the first and second actuating members comprise separate sliders.

Further more preferably, the first and second actuating members are slidable linearly in parallel directions.

It is further preferred that the second spring comprises a compression coil spring co-acting between the first and the second actuating members, with said maximum strain condition being the condition of the coil spring at shortest length.

Preferably, the electrical switch includes a contact separator provided adjacent to the moving contact and movable by the actuating mechanism, upon the actuating mechanism operating towards the first operating condition, to engage and move the moving contact away from the fixed contacts.

More preferably, the separator comprises a pivotable lever.

Further more preferably, the separator has one end engageable and movable by the actuating mechanism and an opposite end for in turn engaging and moving the moving contact.

The electrical switch is preferably a normally-open pushbutton switch.

### BRIEF DESCRIPTION OF DRAWINGS

The invention will now be more particularly described, by way of example only, with reference to the accompanying drawings, in which:

FIG. 1 is a perspective view of an embodiment of an electrical switch in accordance with the invention;

FIG. 2 is a partially-broken perspective view showing certain internal components of the switch of FIG. 1;

FIG. 3 is a side view of the switch of FIG. 2;

FIG. 4 is a simplified side view corresponding to FIG. 3, showing the switch in an open condition; and

FIG. 5 is a simplified side view similar to FIG. 4, showing the switch in a closed condition.

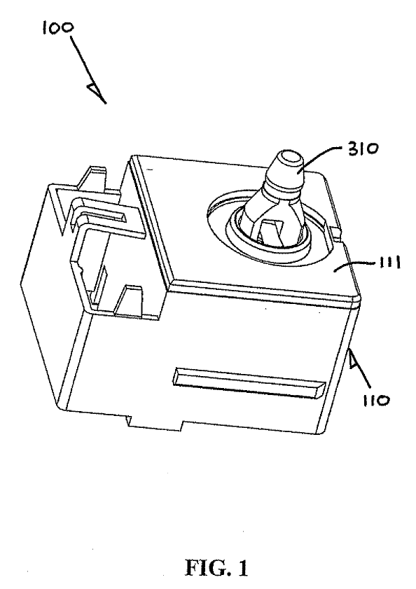

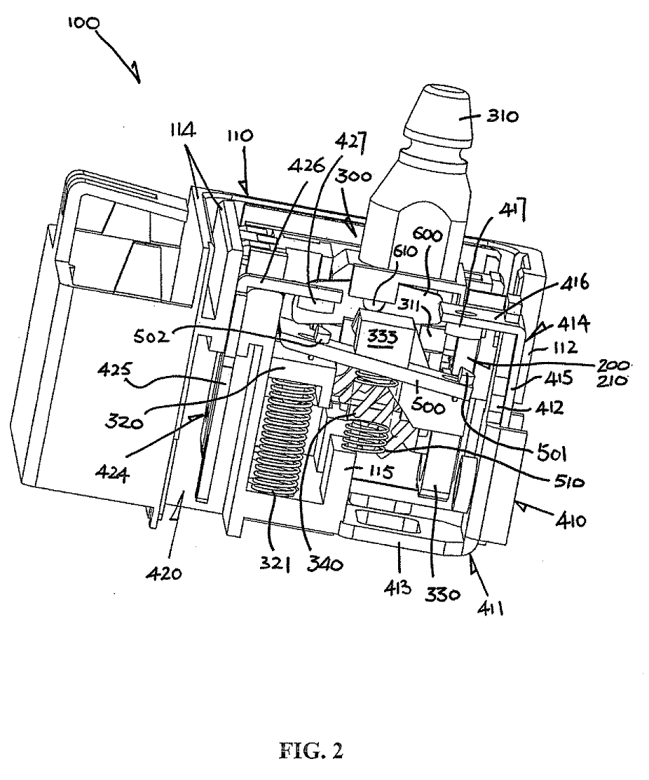

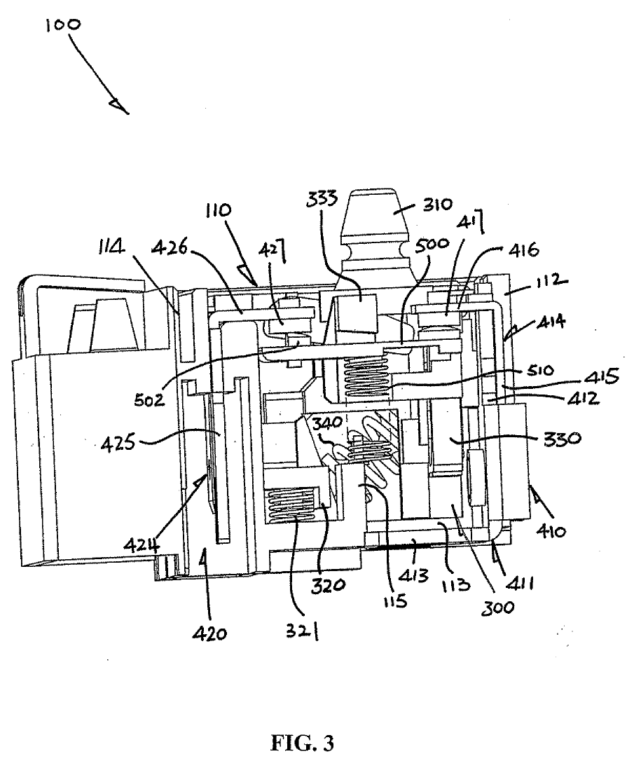

### DETAILED DESCRIPTION OF PREFERRED EMBODIMENT

Referring to the drawings, there is shown an electrical switch in the form of a pushbutton switch 100 embodying the invention. The switch 100 includes a cuboidal plastic casing 110 which has an open top side sealed by a lid 111 and houses a pair of switching mechanisms 210 and a central press actuator 310 therefor. Each mechanism 210 involves a pair of switch terminals 410 and 420 and a moving contact lever 500 for making and breaking electrical connection between the two terminals 410 and 420, together constituting a switch unit 200. The terminals 410 and 420 are located on opposite right and left sides of the casing 110, and the contact lever 500 inside the casing 110.

The two switch units 200 are operated by the actuator 310 in tandem. They are arranged on opposite left and right sides of the actuator 310, having practically the same construction but arranged as mirror images of each other. Only one switch unit 200 is shown in the drawings and described herein for clarity.

The right terminal 410 is formed by two, lower and upper L-shaped copper strips 411 and 414, with the lower strip 411 situated upright and the upper strip 414 inverted, having respective vertical limbs 412 and 415 overlapped in contact alongside a right side wall 112 of the casing 110. A horizontal bottom limb 413 of the lower strip 411 extends and underlies a casing bottom wall 113 for connection of an electric cable for example. A horizontal top limb 416 of the upper strip 414 overhangs inside the casing 110, at the free end of which there is mounted a fixed contact pad 417.

The left terminal 420 is formed by a single inverted L-shaped copper strip 424, which has a vertical limb 425 alongside a left side wall 114 of the casing 110 and a horizontal top limb 426 overhanging inside the casing 110. The bottom end of the vertical limb 425 is exposed for connection of an electric cable for example. A fixed contact pad 427 is mounted at the free end of the top limb 426, at the same horizontal level as the other contact 417.

The contact lever 500 has a straight body provided by a straight copper strip that extends generally horizontally, having opposite ends bearing respective contact pads 501 and 502 which are aligned with the aforesaid fixed contacts 417 and 427 respectively for contact making therewith or contact breaking therefrom to perform switching. A vertical compression coil spring 510 acts upon the contact lever 500 at mid-length thereof, from a fixed support 115 of the casing 110, such that the contact lever 500 is resiliently biased upwardly towards the fixed contacts 417 and 427.

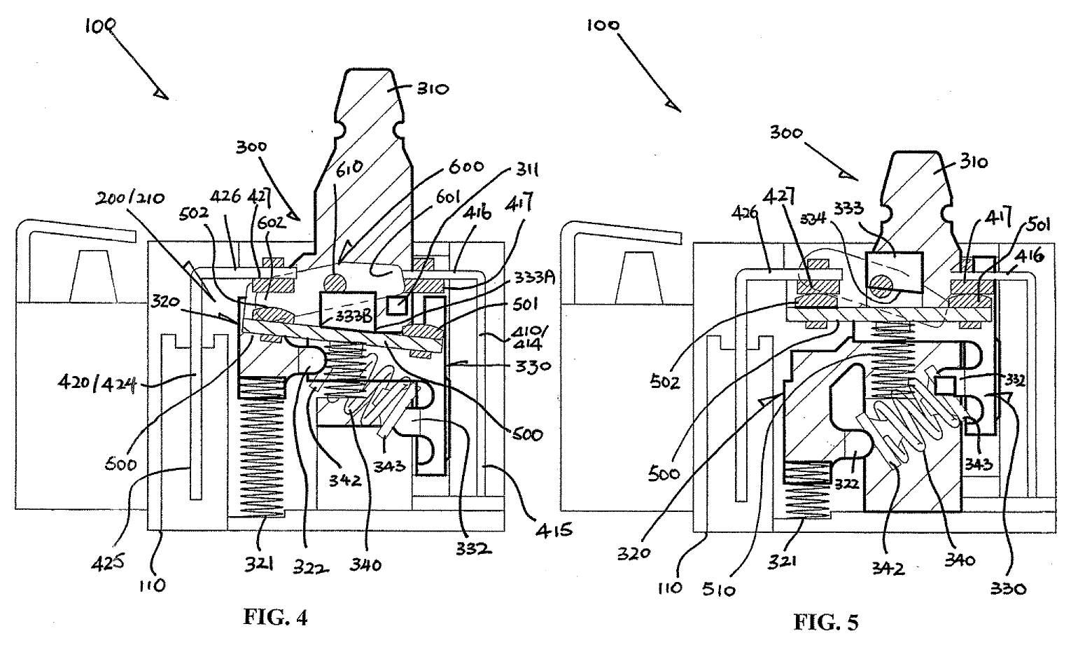

The actuator 310 is part of an actuating mechanism 300 inside the casing 110, which includes a first vertical slider 320 integrally formed with the actuator 310 on the left side of the casing 110, and a separate second vertical slider 330 on the right casing side. The actuator 310 is resiliently biased upwards to stay normally uppermost, i.e. while not being pressed (FIG. 4), by a compression coil spring 321 that acts upon the first slider 320 from below. Thus, the first slider 320 also normally stays uppermost.

There is a relatively strong coil spring 340 which is compressed, extending at an acute angle, between the two sliders 320 and 330. Opposite ends of the spring 340 engage respective lateral projections 322 and 332 of the sliders 320 and 330 via individual pivoting bearings 342 and 343. The spring 340 co-acts between the sliders 320 and 330 to resiliently force them apart such that they tend to slide and stay at opposite uppermost and lowermost positions. Consequently, the second slider 330 normally stays lowermost (FIG. 4).

In such a normal operating condition of the actuating mechanism 300, while in the lowermost position, the second slider 330 engages upon the contact lever 500 from above by means of an integral hook 333 thereof situated right over the contact lever 500, at mid-length thereof. The hook 333 is provided by a thickened portion of a top end of the second slider 330, having a slightly inclined flat surface 334 engaging the contact lever 500 such that the contact lever 500 is retained downwardly, against the action of the spring 510, at a correspondingly inclined position (FIG. 4).

The subject switch 100 is thus normally-open, in that the contact lever 500 is retained at a slightly inclined position by the second slider 330, counteracting the spring 510, from contacting the fixed contacts 417 and 427 or short-circuiting the switch terminals 410 and 420 (FIG. 4).

In operation, during pressing of the actuator 310 (from FIG. 4), upon sufficient lowering of the first slider 320 causing the spring 340 to pivot, or bend, past its shortest length condition in the horizontal position i.e. maximum strain condition, the spring 340 is instantly released and hence flicks the second slider 330 upwards to its uppermost position (FIG. 5).

Given that the second slider 330 will move upwards with its hook 333 beyond the fixed contacts 417 and 427, the contact lever 500 will follow the hook 333 to rise under the action of its own spring 510. The lever 500 will first move into contact with the left fixed contact 417 and then turn horizontal to engage the right fixed contact 427, thereby completing the electrical circuit across the terminals 410 and 420.

The subject switch 100 is then closed in this alternative operating condition of the actuating mechanism 300, temporarily for as long as the actuator 310 remains depressed.

On release of the actuator 310 (from FIG. 5), upon rising of the first slider 320 (by the spring 321) pivoting, or bending, the spring 340 past its shortest length condition in the horizontal position i.e. maximum strain condition, the spring 340 is instantly released and hence flicks the second slider 330 downwards back to its original lowermost position (FIG. 4). En route to the lowermost position, the second slider 330 has its hook 333 hit and pull the contact lever 500 downwardly, against the action of the spring 510, away from the fixed contacts 417 and 427, whereby the subject switch 100 is re-opened.

With its planar surface 334 inclined at a small angle of about 3° to 5° from horizontal, the hook 333 has a bottom right corner 333A that is slightly lower than a bottom left corner 333B thereof, on opposite sides about the axis of the lever spring 510. During switch opening, the right corner 333A will initially engage the contact lever 500 at one position on the right side about the spring 510, with the left corner 333B subsequently engaging the contact lever 500 at another position on the opposite left side about the spring 510.

As the contact lever 500 is initially engaged on the right side of the axis of its supporting spring 510, it will first be pivoted clockwise about the left fixed contact 427, thereby coming out of contact from the right fixed contact 417 first. On continual pivoting, the contact lever 500 will lie flat against the hook surface 334 and be further pressed downwards at the inclined position to also break away from the left fixed contact 427.

This arrangement ensures that the contact lever 500 will make contact with the left fixed contact 427 first, and more importantly to break contact from the other, right fixed contact 417 first. It is therefore possible to make only the right fixed contact pad 417 and the associated contact pad 501 of the lever 500 more robust to withstand contact arcing and/or flashover that are inevitable, thereby rendering the switching action weld-safe and/or non-tease.

The surface 334 of the actuator hook 333 inclined relative to the two fixed contacts 417 and 427 ensures that the contact lever 500 makes contact with and, more importantly, breaks contact from the fixed contacts 417 and 427 at different moments in time. The same result can be achieved in several other ways that can be taken instead or concurrently, for example by inclining the two fixed contacts (i.e. located at different levels) relative to the contact lever, or using a slightly folded or angled contact lever to incline its opposite end contact pads relative to the fixed contacts.

The aforesaid flicking of the second slider 330 by the first slider 320 or the actuator 310 via the spring 340 upon release is rapid and ensures instant contact making and, in particular, contact breaking to alleviate the problem associated with contact arcing and/or flashover.

For double precaution, the subject switch 100 includes a contact separator in the form of a plastic lever 600 for actively separating the contact lever 500 from the fixed contacts 417 and 427. The separator 600 is supported at mid-length by a hinge pin 610 located in the casing 110, for limited pivotal movement.

Opposite ends 601 and 602 of the separator 600 are positioned above a side projection 311 of the actuator 310 and the left end of the contact lever 500 (adjacent to the left contact pad 502) respectively. Upon rising of the actuator 310 on release, its projection 311 hits the right end 601 of the separator 600 from below to thereby pivot the other end 602 downwards, which in turn hits the contact lever 500 (at its left end) from above to assist or ensure separation of the contact lever 500 from the fixed contacts 417 and 427.

In general, the subject electrical switch may not need to be a pushbutton switch and can be, for example, a rocker or toggle switch. It is also not necessarily a normally-open switch.

The invention has been given by way of example only, and various other modifications of and/or alterations to the described embodiment may be made by persons skilled in the art without departing from the scope of the invention as specified in the appended claims.

1. An electrical switch comprising:
a casing;
two fixed contacts and a moving contact in the casing;
a first spring resiliently biasing the moving contact towards contacting the fixed contacts to thereby close the switch; and
an actuating mechanism for causing movement of the moving contact relative to the fixed contacts, the mechanism being operable between a first operating conditions in which the moving contact is moved out of contact with the fixed contacts against action of the first spring, and a second operating condition in which the moving contact comes into contact with the fixed contacts under action of the first spring, wherein
the actuating mechanism has an engaging member for engaging and retaining the moving contact in contact with the fixed contacts in the first operating condition and includes a second spring acting on the engaging member for moving the moving contact out of contact with the fixed contacts through an instant spring-release action; and
at least one of the engaging member and the two fixed contacts is configured such that the moving contact will be engaged and moved by the engaging member out of contact with a first of the fixed contacts earlier than with a second of the fixed contacts.

2. The electrical switch as claimed in claim 1, wherein the engaging member engages the moving contact at a first position on a first side of the moving contact, about the first spring and relatively closer to the first of the fixed contacts than to the second of the fixed contacts.

3. The electrical switch as claimed in claim 2, wherein the engaging member has a first region arranged to initially engage the moving contact at the first position on a first side of the moving contact, about the first spring and relatively closer to the first of the fixed contacts than to the second of the fixed contacts, and includes a second region arranged to subsequently engage the moving contact at a second position on an opposite side of the moving contact from the first side, about the first spring.

4. The electrical switch as claimed in claim 3, wherein the first and second regions lie on a plane which is inclined at an angle relative to the two fixed contacts.

5. The electrical switch as claimed in claim 4, wherein the first and second regions are provided by a flat surface of the engaging member on the plane.

6. The electrical switch as claimed in claim 1, wherein the moving contact has a straight body.

7. The electrical switch as claimed in claim 1, wherein the actuating mechanism includes a first actuating member for manual movement and a second actuating member comprising the engaging member and movable by the first actuating member via the second spring past a maximum strain condition of the second spring to perform the instant spring-release action.

8. The electrical switch as claimed in claim 7, wherein the first and second actuating members comprise separate sliders.

9. The electrical switch as claimed in claim 8, wherein the first and second actuating members are slidable linearly in parallel directions.

10. The electrical switch as claimed in claim 8, wherein the second spring comprises a compression coil spring co-acting between the first and the second actuating members, with the maximum strain condition being compression of the coil spring to a shortest length.

11. The electrical switch as claimed in claim 1, including a contact separator located adjacent to the moving contact and movable by the actuating mechanism, upon the actuating mechanism operating towards the first operating condition, to engage and move the moving contact away from the fixed contacts.

12. The electrical switch as claimed in claim 11, wherein the separator comprises a pivotable lever.

13. The electrical switch as claimed in claim 12, wherein the separator has a first end engageable and movable by the actuating mechanism and a second end, opposite the first end, for engaging and moving the moving contact.

14. The electrical switch as claimed in claim 1, being a normally-open pushbutton switch.
